(19) United States
(12) Patent Application Publication
(10) Pub. No.: US 2014/0058739 A1
(43) Pub. Date: Feb. 27, 2014

(54) METHOD FOR MANAGING HEALTHCARE APPOINTMENTS

(71) Applicant: Manuel Ignacio Guerra-Mondragon Gonzalez, San Juan, PR (US)

(72) Inventor: Manuel Ignacio Guerra-Mondragon Gonzalez, San Juan, PR (US)

(21) Appl. No.: 13/592,209

(22) Filed: Aug. 22, 2012

(51) Int. Cl. G06Q 50/22

(52) U.S. Cl. 705/2

(57) ABSTRACT

Method and apparatus for the management of healthcare patient and practitioner profile information prior to visit a practitioner's office. The method provides online booking of available appointment times for registered physicians. The online booking process can simultaneously be used to manage and schedule appointments for family members.

### STATEMENT REGARDING FEDERALLY SPONSORED RESEARCH AND DEVELOPMENT

N/A

### RELATED APPLICATIONS

N/A

### BACKGROUND OF THE DISCLOSURE

1. Field of the Disclosure

The present disclosure relates to a method and apparatus for managing and scheduling healthcare appointments for an user and/or individuals related to the user with practitioners (e.g. physicians) without the intervention of a third party.

2. Discussion of the Background

Currently physician profiles are typically provided on websites to enable actual or prospective patients to search for a particular healthcare practitioner. Prospective patients are generally invited to contact the physician's office by telephone or visit the physician's practice.

The problem with contacting the physician's office is that generally the patient has to wait their turn to be attended due to the limitation in administrative personnel. Further the booking availability, more particularly selecting the time and date for an appointment could take several minutes when you are not able to see or be provided with several options.

Therefore, there is a need to overcome the limitation provided by the current systems which make the managing and scheduling of an appointment not a complicated task.

### SUMMARY

The present disclosure overcomes the limitations of the previous systems and methods for managing and scheduling of healthcare appointments.

Accordingly, it is an object of the present disclosure to provide an electronic scheduling and managing system for scheduling appointments without the intervention of a third party. The first exemplary embodiment in accordance with the principles of the present disclosure comprises a first communication device manipulated by a patient, a computing platform that receives and processes the patient requests directed to managing and/or scheduling an appointment, a second communication device manipulated by a physician or physician's assistant wherein the exchange of information is established across a communication channel, such as a network.

The computing platform includes storage means, options to customize/edit the patient's profile and the physician's profile, wherein the patient's profile comprises personal information, insurance information and family information. The physician profile comprises physician's information, specialties, accepted insurances and office hours.

The first communication device and second communication device for exchanging digital messages/information across a network comprises any communication device capable of storing digital information such as a personal computer, mobile telephone, smart phone or mainframe computer configured to perform various functions and operations. Other information, such as information to identify the patient and the physician can be received by the computing platform.

It is another object of the present disclosure to provide a computing platform including a transaction control system comprising means to access the practitioner calendar information and an authorization system. In accordance with the principles of the present disclosure a first data base is provided to store information regarding practitioner specialties, availability and more practitioner information. Further, the authorization system comprises an authorization request including particular patient information, hour requested for appointment, and the request for physician's approval.

Another object of this disclosure is to provide a computing platform that using a sequence of instructions generates and stores information associated to a patient and family.

In accordance with the principles of the present disclosure the computing platform using a sequence of instructions generates a profile associated with a patient and/or a physician.

Further, in accordance with the principles of the present disclosure the computing platform using a sequence of instructions generates a confirmation code for authentication procedures.

It is another object of this disclosure to provide a computing platform that notifies the patient's appointment status by exchanging digital messages across a network. In accordance with the principles of the present disclosure the computing platform generates a digital message providing information of the appointment status, wherein said appointment status comprises “cancelled” or “confirmed”.

Further, the computing platform, through the transaction control system, requests and authorizes the appointments. After validation procedures by the physician the confirmation is provided to the patient.

Yet another object of the present disclosure is to provide a transaction control system which generates multiple requests by the patient. The request includes accessing a master account to add or retreat family members' information. In accordance with the principles of the present disclosure the transaction control system serves for adding information related to patient's family members.

It is another object of this disclosure to provide a transaction control system which stores transactional information and generates a report related to the patient's history of appointments and user behavior.

The disclosure itself, both as to its configuration and its mode of operation will be best understood, and additional objects and advantages thereof will become apparent, by the following detailed description of a preferred embodiment taken in conjunction with the accompanying drawings.

The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the disclosure of the application, which is measured by the claims, nor is it intended to be limiting as to the scope of the disclosure in any way.

### BRIEF DESCRIPTION OF THE DRAWINGS

The accompanying drawings, which are incorporated herein, constitute part of the specification and illustrate the preferred embodiment of the disclosure.

FIG. 1 shows a general structure of the present disclosure in accordance with the principles of the present disclosure.

FIG. 2 shows a flowchart exemplary embodiment of the uploading process for patient's information in accordance with the principles of the present disclosure.

FIG. 3 shows a more detailed diagram of the systems and methods for editing information at computing platform data base in accordance with the principles of the present disclosure.

FIGS. 4A through 4B show flowcharts exemplary embodiments of the systems and methods for scheduling appointments in accordance with the principles of the present disclosure.

FIGS. 5A through 5B show flowcharts exemplary embodiments of the systems and methods for searching a specialist and scheduling appointments in accordance with the principles of the present disclosure.

FIG. 6. shows an exemplary embodiment of the graphical user interface for the login and/or new account registration process in accordance with the principles of the present disclosure.

FIG. 7. shows an exemplary embodiment of the graphical user interface for the patient's scheduling process in accordance with the principles of the present disclosure.

FIG. 8. shows an exemplary embodiment of the graphical user interface for the patient search and selection process of a physician in accordance with the principles of the present disclosure.

FIG. 9A through 9B show exemplary embodiments of the graphical user interface for the patient's appointment selection in accordance with the principles of the present disclosure.

FIG. 10. shows an exemplary embodiment of the graphical user interface for the patient's appointment confirmation in accordance with the principles of the present disclosure.

FIGS. 11A through 11D show exemplary embodiments of the graphical user interface for the management options of patient's profile in accordance with the principles of the present disclosure.

FIG. 12 shows a flowchart exemplary embodiment of the uploading process for physician's information in accordance with the principles of the present disclosure.

FIG. 13A through 13B show a flowchart exemplary embodiment of the doctor's process after receiving a request from patient in accordance with the principles of the present disclosure.

FIG. 14. shows an exemplary embodiment of the graphical user interface for the physician's profile management features in accordance with the principles of the present disclosure.

FIG. 15. shows an exemplary embodiment of the graphical user interface for the physician's confirmation process in accordance with the principles of the present disclosure.

FIGS. 16A through 16C show exemplary embodiments of the graphical user interface for the management options of physician's profile in accordance with the principles of the present disclosure.

FIG. 17 shows a flowchart exemplary embodiment of the report's request in accordance with the principles of the present disclosure.

### DESCRIPTION OF THE PREFERRED EMBODIMENT

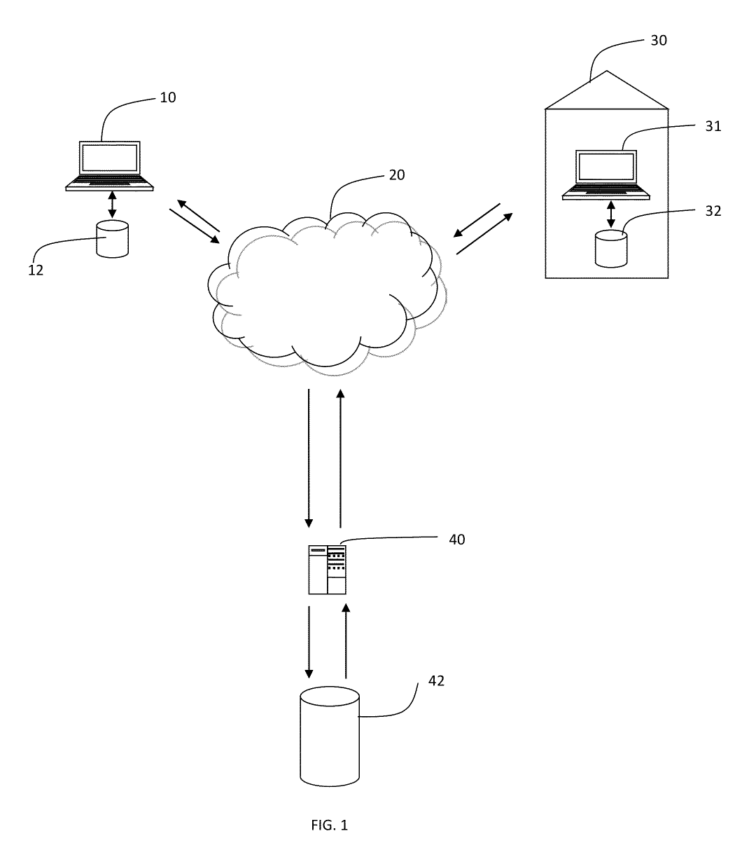

Referring to FIG. 1, a method for managing healthcare appointments comprising a network 20, a first communication device 10 manipulated by a patient, a computing platform 40; and a second communication device 30 manipulated by a physician's administrative team comprising at least an electronic communication device 31 and a physician's data base 32, wherein said second communication device 30 validates a patient request through the computing platform 40.

The computing platform 40 includes a data base 42, means to generate and receive a request from a patient and means to generate digital messages with particular notifications across a network 20. The computing platform 40 is described in more details below.

The first communication device 10 comprises a computer, such as a personal computer or any other device having computation characteristics that connects or communicates through the network 20, such as a LAN, WAN, intranet or the Internet, with the computing platform 30. The first communication device 10 is connected to the computing platform 30 for the purpose of receiving information about patient or user, such as scheduling appointments; verify appointments, healthcare reports and more. The communication between the first communication device 10 and the computing platform 30 is via wired and a wireless configuration.

Further, the first communication device 10 may include a wide variety of devices to receive and/or provide the data as input to computing platform 30. For example, the first communication device 10 may include a keyboard, mouse, touchscreen, disk drive, video camera, magnetic card reader, or any other suitable input device for providing patient data to the computing platform 30.

Once the first communication device 10 communicates with the computing platform 40 through the network 20, particular information is required to access the computing platform 40 for several purposes. For example, the computing platform 40 is at least accessed by the patient to upload health related information, search for a particular specialist and/or to verify appointments.

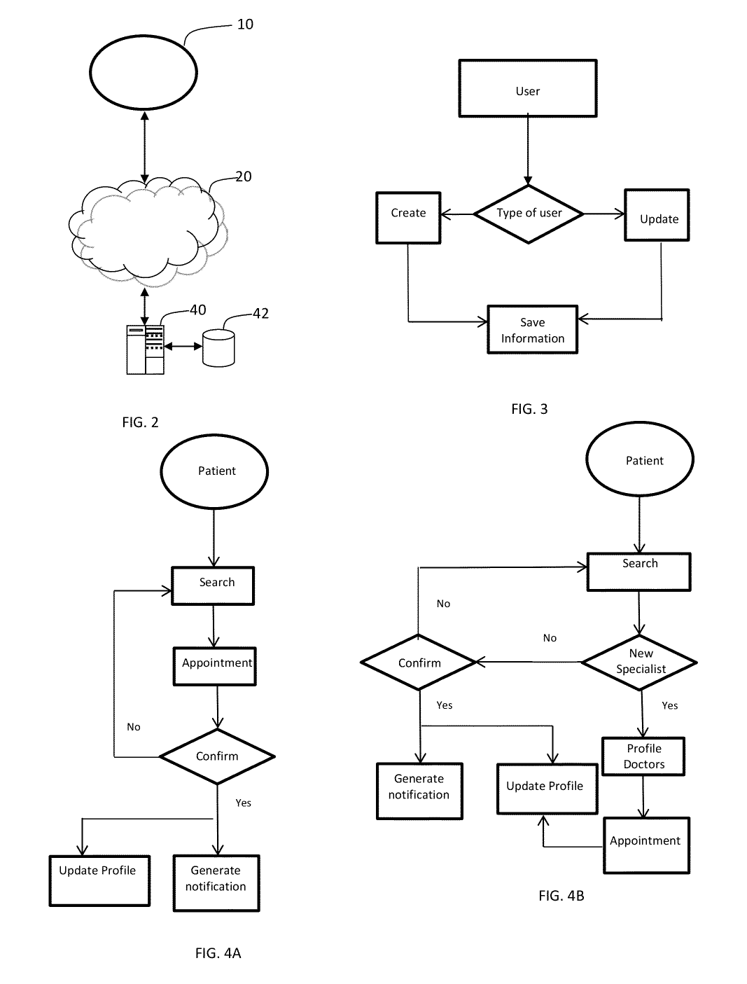

Therefore, as mentioned before, one of the objects in accordance with the principles of the current disclosure is to request appointments from several patients. FIG. 2 is directed to the general computing platform access process for the current disclosure. The patient accesses the computing platform 40 through the network 20 and includes or adds its personal information as part of the systems requirements for healthcare management. The computing platform 30 includes at least or may be otherwise operatively coupled to a database 31, which may be used to store patient information. FIG. 3 is directed to the process to incorporate patient information as a new user or to update information as a previous user into the data base 31 in order to request an appointment and provide patient's information to the physician during the patient's appointment request. The database 31 may include more than one database or other type of electronic repository.

In order to access the computing platform 40 by the patient as a new user, said patient has to contact a computing platform administrator. The process is completed by any communication device such as a computer. Next, the patient accepts a set of rules and/or guidelines, such as a contract, provided by the computing platform administrator. The agreement between the parties depends on the patient history and others. After patient acceptance of the contract's rules the computing platform administrator adds the patient's information to the data base 31 by means of the computing platform 30. The patient's information comprises the patient's name, contact information, health problem, sex, age, date of birth, family members, family health history, location, blood type, allergies, insurance, expiration date and other information related to patient.

After the process of adding the patient information to the data base 42 the computing platform 40, using a sequence of instructions, such as a program, generates a patient profile with a code per patient. The patient profile is designated to identify at least the patient and the patient's family members. Further, a patient profile, explained below, is accessed by the physician through the computing platform 40. The patient profile is provided to identify a particular health care issue.

FIG. 4A through FIG. 4B are directed to the process for scheduling and requesting an appointment. In accordance with the principles of the current disclosure, a computing platform 40, by means of a transaction control system and a portal, more particularly a web portal, is used for booking healthcare appointments across the network 20. One the patient is logged in to the system and the physician is part of the computing platform 40 data base 42 the appointment will be booked via the portal. The booking procedure comprises accessing the patient profile first and selecting the person with healthcare concerns thereafter. This applies for patient profiles with more than one person, more particularly for patient profiles with several family members.

After accessing the profile and selecting the person who will be attending to the appointment the user searches for a doctor depending on a particular illness or specialist. For example, if the user is looking for a pneumologist or is feeling symptoms such as headache, congestion and head pressure the computing platform suggest a list of several pneumologists. The list will give priority to the pneumologists that are part of the computing platform 40. The main reason is that in order to use the computing platform to schedule an appointment the physicians have to provide access to his/her calendar. The computing platform only accesses the physician calendar after the physician is registered in the system.

As shown in FIG. 4A, the next step after selecting the physician is to schedule an appointment. A list of available appointments including dates and times are presented to the patient. Further, the patient makes an informed selection that satisfies the needs of this specific patient and/or family member. The patient is provided with the available appointment times provided by the physician's administrative team. Further, the patient is provided with options for selecting the available appointment slot, health insurance plan, authorize physicians for accessing his/her patient's profile, verify physician reviews and others.

The first time a patient requests a service from a physician, said patient has to wait for the physician's confirmation, as shown in FIG. 4A. If the request is denied said patient has to search and select another physician and request another appointment. If the physician accepts the request the physician becomes part of the patient profile and can access the physician's calendar without the physician's confirmation, as shown in FIG. 4B. A notification is provided for every time the patient requests an appointment. Said notification is generated by the transaction control system.

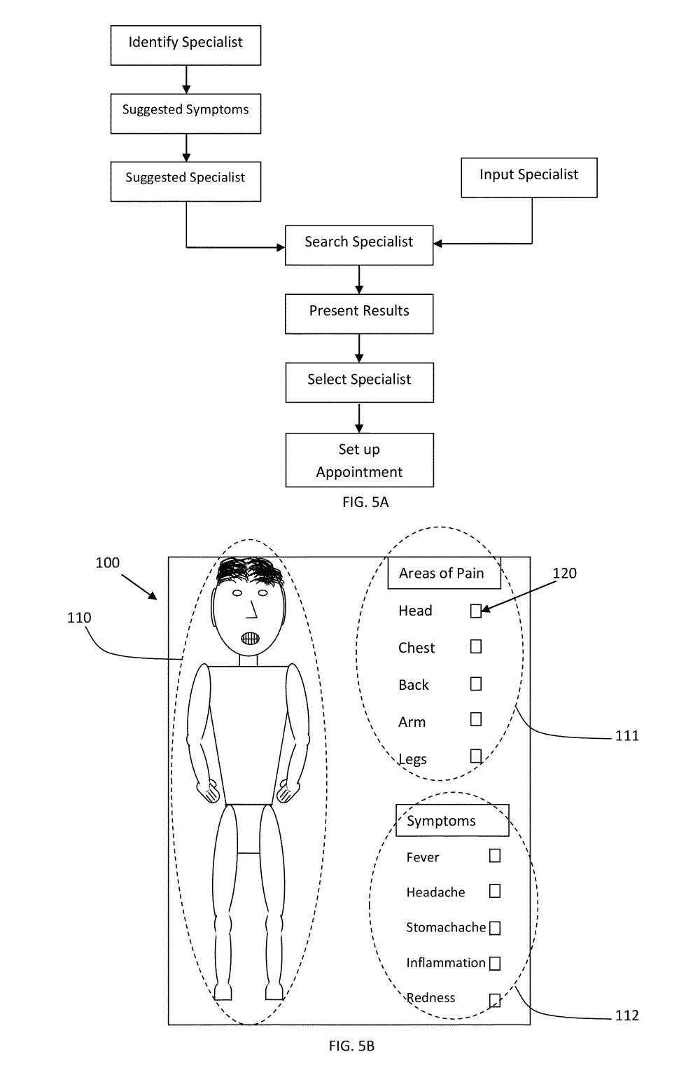

Another object of the present disclosure is to provide a method that assists with the specialist/physician search. The process for scheduling and requesting an appointment, as shown in FIG. 5A, comprises at least two processes to make a query for the search of a specialist and/or physician. The first process comprises the request of a preferred specialist by providing the name or any particular information to identify a specialist uploaded to the system by means of the input device.

The second process to complete a query for a specialist may comprise several steps to assist the user with the selection of the specialist by suggesting some symptoms. Once the system recognizes the system provided by the patient by means of an input device, such as a photo, keyboard or any other input device, the system provides a list of possible specialists to the patient.

Sequences of instructions are provided by the computing platform in order to perform a search for a specialist/physician. In accordance with an exemplary embodiment of the present disclosure, as shown in FIG. 5B, an interactive graphical unit interface (GUI) 100 with list of symptoms may be provided to patient for the selection of information relevant to a specialist. The GUI 100 comprises an area for selecting the area of pain 111 and/or area of symptoms 112. Further the GUI may include a body representation in order to identify part or areas affected. The selection is submitted to the computing platform 40, which as explained above, with a sequence of instructions suggests a list of possible specialists to visit base on the information submitted by the patient.

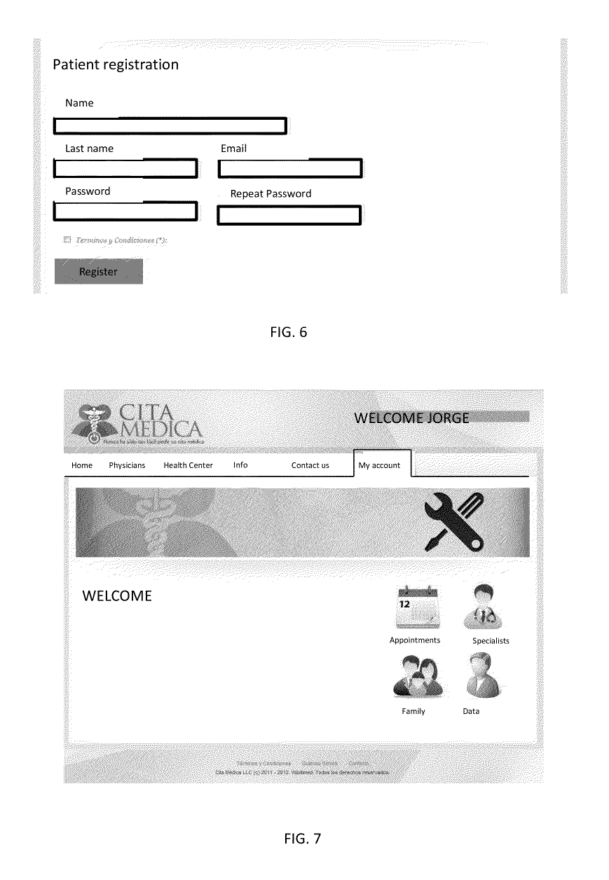

FIG. 6 through FIG. 12D are directed to exemplary embodiments of the graphical user interfaces for the patient login and/or new account registration process, the patient's scheduling process, patient's search and selection process of a physician, the appointment date and hour selection, the patient's appointment confirmation request, the patient's appointment confirmation and the management options of patient's profile.

FIG. 6 is directed to the registration procedures. Particular information is required, as mentioned before. Once the patient accesses the process for scheduling and requesting an appointment a Graphical unit with general options is provided, as shown in FIG. 7.

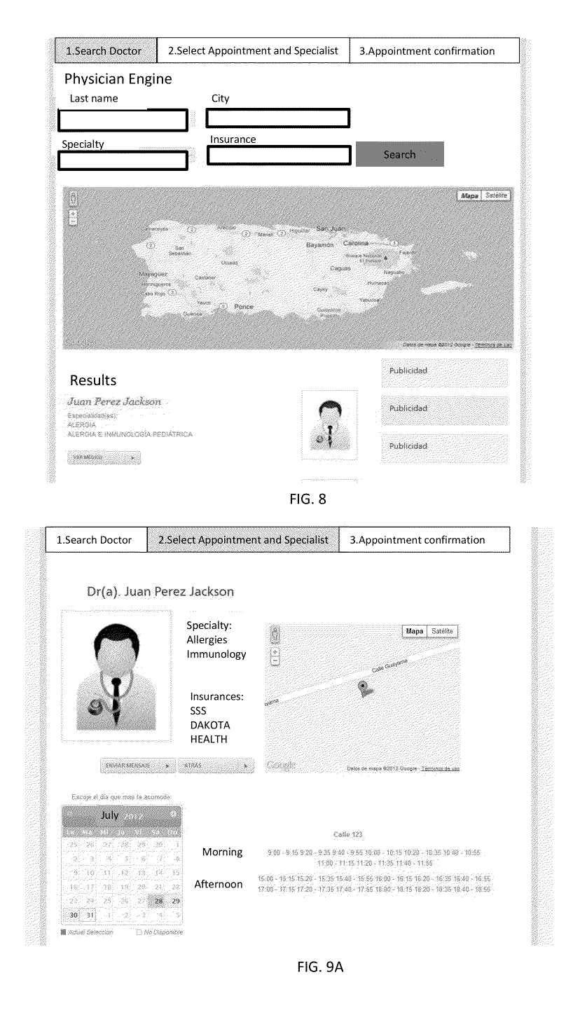

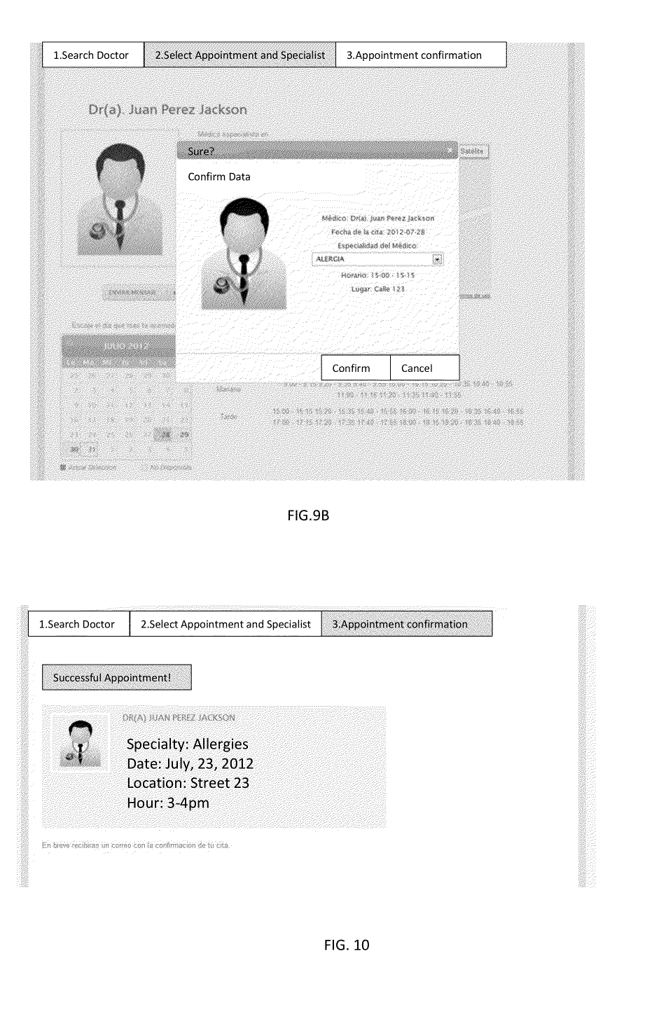

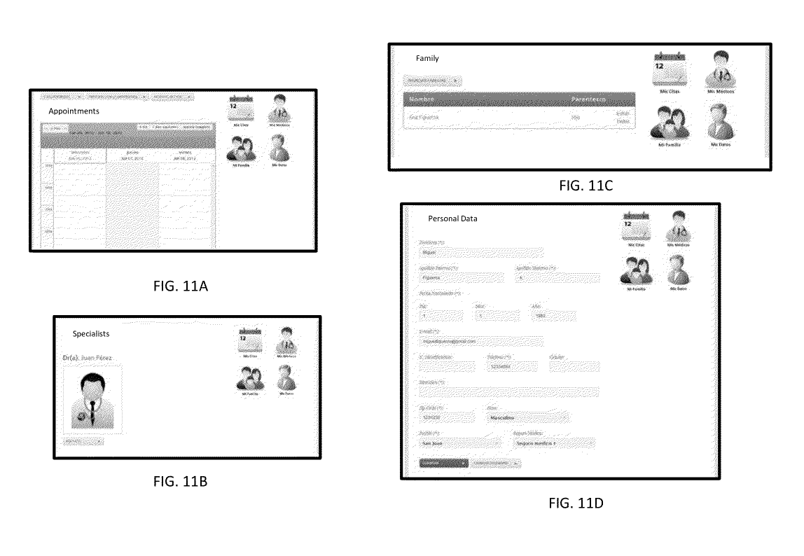

FIG. 8 through FIG. 10 are directed to the process of scheduling an appointment. The process is based on three steps. The first step is the searching process. The patient types at least one of the following: name, city, specialty or insurance. Depending on the query and limitations provided by the patient the computing platform 40 completes a search primarily considering the specialist saved in the data base 42. The second step is to select the appointment and the specialist. A graphical unit interface providing the specialist and available hours is presented to the user. The patient selects the most convenient specialist. Once the selection is performed the system verifies the selection by asking the patient, as shown in FIG. 9B. The third step is the confirmation of the appointment, as shown in FIG. 10. The confirmation process is included in the present disclosure. FIG. 11A through FIG. 11D are directed to additional GUIs provided by the computing platform 40. For example, the computing platform 40, in accordance with the principles of the present disclosure provides a calendar GUI to verify appointments, a specialist GUI to verify specialists' information when needed, family GUI to verify the family's docket and appointments and a personal data GUI to verify personal information including information regarding family members.

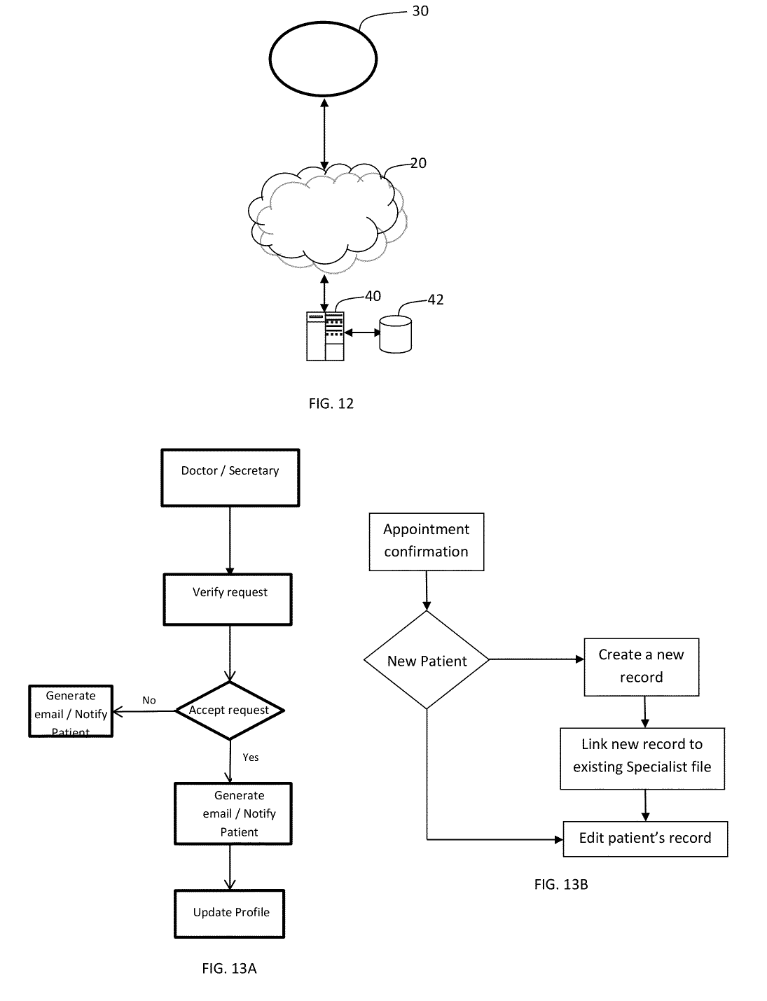

FIGS. 12 through 17B are directed to the physician procedure to become part of the computing platform data base 40. In accordance with the principles of the present disclosure the registration process is similar to the patient registration procedure, as shown in FIG. 12, the physician administration team by means of the second communication device and the computing platform 40 generates and manages a physician's profile.

The second communication device 30 comprises a computer, such as a personal computer or any other device having computation characteristics that connects or communicates through the network 20, such as a LAN, WAN, intranet or the Internet, with the computing platform 30. The second communication device 10 is connected to the computing platform 30 for the purpose of receiving information about a physician, such as his/her calendar, specialties, certifications and more. The communication between the second communication device 30 and the computing platform 40 is via wired and a wireless configuration.

Further, the second communication device 10 may include a wide variety of devices to receive and/or provide the data as input to computing platform 40. For example, the second communication device 30 may include a keyboard, mouse, scanner, touchscreen, disk drive, video camera, magnetic card reader, or any other suitable input device for providing the physician's data to the computing platform 30.

Once the second communication device 30 communicates with the computing platform 40 through the network 20, particular information is required to access the computing platform 40 for several purposes. For example, the computing platform 40 is at least accessed by the physician to upload health related information, such as seasonal viruses, special care to a particular illness for all patients related or part of a patient's profile, search for a particular patient and/or to verify/confirm appointments.

In accordance with the principles of the current disclosure another objective is to create a profile that can be accessed by patient and also provide enough information for assisting the patient's selection for appointments. FIG. 12 is directed to the general computing platform access process for the current disclosure. The physician's administrative team accesses the computing platform 40 through the network 20 and includes or adds its physician's information as part of the systems requirements for healthcare management. The computing platform 40 includes at least or may be otherwise operatively coupled to a database 42, as mentioned before, which may be used to stored physician information. The physician may access the computing platform 40 as a new user or update information in the data base 42 in order to provide current status for the patient's benefit. This includes, and is not limited to, vacations, change of address, new drugs for a particular disease, change in practice, certifications and more. The update is stored at the database 42, which may include more than one database or other type of electronic repository but also is saved at the second communication device 31.

In order to access the computing platform 40 the physician, as a new user, has to contact a computing platform administrator. The process is completed by any communication device such as a computer, telephone, fax and/or as part of the registration procedure. Next, the physician accepts a set of rules and/or guidelines, such as a contract, provided by the computing platform administrator. The agreement between the parties depends on the physician's specialties and others. After the physician's acceptance of the contract's rules the computing platform administrator permits access of the physician's information to the database 42 by means of the computing platform 40. The physician's information comprises the physician's name, contact information, specialties, certifications, practitioners group, back ground, location, accepted insurances and other information related to the physician.

After the process of adding the physician's information to the database 42 the computing platform 40, using a sequence of instructions, such as a program, generates the physician's profile with an unique code per physician. The physician profile is designated to identify at least the physician's background, specialty and available time. Further, a physician's profile is accessed by the patient through the computing platform 40, as explained above.

FIG. 13A and FIG. 13B are directed to the process for verifying and confirming an appointment. In accordance with the principles of the current disclosure, a computing platform 40, by means of a transaction control system and a portal, more particularly a web portal, is used for verifying patient requests and/or healthcare appointments across the network 20. Once the physician's administrative team is logged in to the system and the physician's profile is created the confirmation procedure comprises accessing the physician profile, accessing the appointment requests and the confirmation and/or denial of the request. A notification is generated by the transaction control system.

The physician's administrative team comprises the physician and secretaries or other personnel working on behalf of the physician. When multiple members are part of a physician's administrative team a main member has absolute control over the physician's accounts. The main member controls or limits the access of the other member belonging to a particular physician's administrative team.

Once the physician's administrative team accepts a request he or she becomes part of the patient's profile. The computing platform saves this information and considers it for the search queries performed by the patient. In the instant case the patient is empowered to limit the physician's access to the patient's profile. For example, if a physician's service is not proper or up to the standards of the patient, said patient may delete the physician from the patient's profile. The deletion of a physician from a profile is saved at the computing platform database 41. Also, this information is considered when the patient performs a query that fits the deleted physician's profile.

On the other hand, if a patient fails to show up to an appointment the practitioner submits the information to the computing platform 40. The transaction control system saves the information in the computing database 31. The cancellation of an appointment may result in a fee for the patient. The transaction control system may generate the notification and invoice to the patient if required by physician.

Further, another object of the present invention is to provide an electronic file system. In accordance with the principles of the present disclosure ones a physician administrative team confirms an appointment a client profile related to the patient profile is created. The client profile includes information provided by the patient. In some case several physicians may have a physical repository for saving patient's information, such as medical records. The system provides means to correlate the client profile with the physical medical record by providing or uploading the medical record number. In this way the physician can keep an electronic and physical repository for the patient's medical record. The record, as mentioned above, is created only for the first patient's appointment, as shown in FIG. 15B. Further every time a patient's appointment is confirm the computing platform device 40 just upload the physician record corresponding to the particular patient.

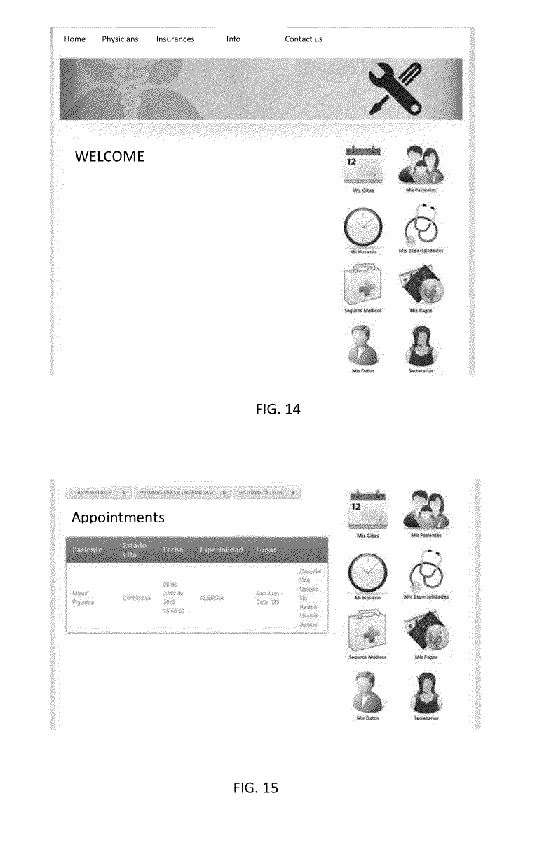

FIG. 14 through FIG. 16C are directed to exemplary embodiments of the graphical user interfaces for the physician's profile management features, physician's confirmation process and the management options of physician's.

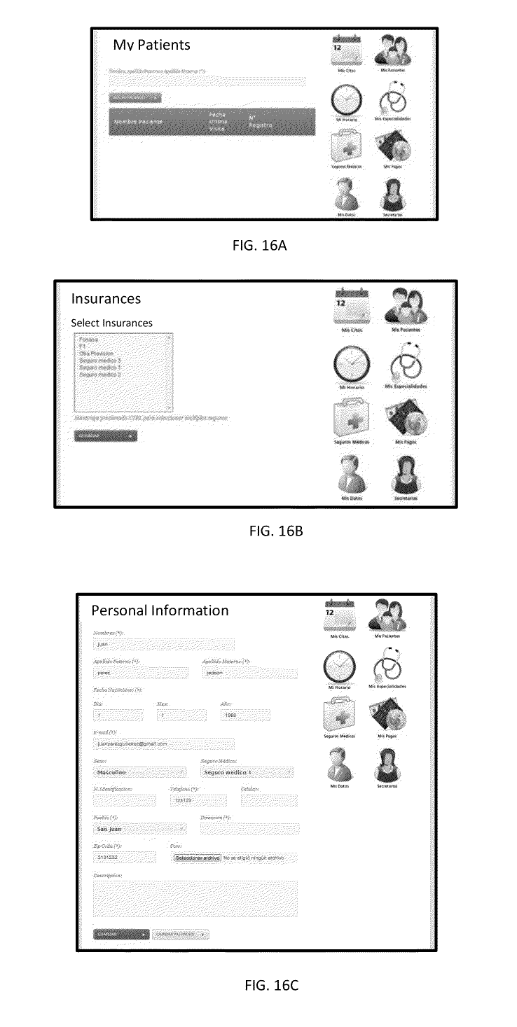

FIG. 14 is directed to the physician graphical unit interface once the physician accessed his/her profile to verify and manage his/her information. The computing platform 40, in accordance with the principles of the present disclosures provides an Appointment GUI to verify appointments, as shown in FIG. 15. The Appointment GUI provides the information necessary to confirm or deny appointments. Further other interfaces such as, My Patient's GUI to verify patients' information when needed, Insurance GUI to verify accepted insurances and a Personal Data GUI to verify personal information including information regarding vacations, special certifications and specialties, as shown in FIG. 16A through FIG. 16C.

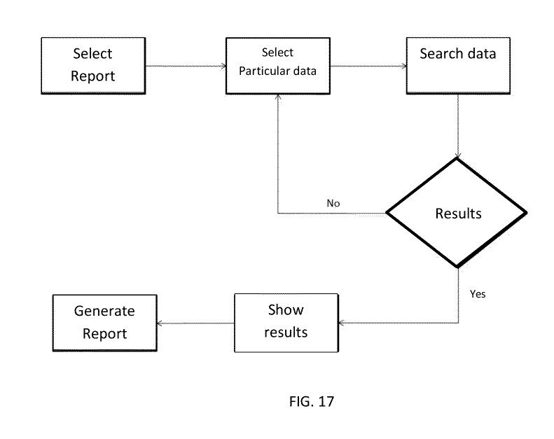

FIG. 17 is directed to the reporting feature of the current disclosure. Another object of the present disclosure is to provide a better understanding of the health condition of each patient and physician's practice. As mentioned before, a transaction control system, manages the requests, confirmation and others features related to the health care management. The system provides comprises the following steps:
User selects report;
User selects information required to be presented in report. For the patient this may include, but is not limited to, appointments, cost per appointment, appointments per year, appointments per year per physician and more. For the physician this may include, but is not limited to, cancelations, number of appointments per month/year, graphics on attendance per patient, average location and age of patients and more;
System searches for selected data;
System provides results. The results depend on the information selected to be in the report. If the requested information is not available the user may provide another search;
System displays results. The results may be presented as a table, graphic or any other tangible or visible display of the results. Several sequences of instructions may be used to complete the present task based on the results obtained from the previous search of the information saved at the computing platform data base 42;
System generates report. The report may be send as electronic communication to the patient and/or the physician. If required by the patient and/or physician the report can be sent to a third party (i.e. account manager, members of the physician administrative team and others).

It is important to understand that the term physician includes doctors, or any health care provider. Further, during the health care managing procedure or the physician profile updates the term physician includes other physician administrative team members. The disclosure is not limited to the precise configuration described above. While the disclosure has been described as having a preferred design, it is understood that many changes, modifications, variations and other uses and applications of the subject disclosure will, however, become apparent to those skilled in the art without materially departing from the novel teachings and advantages of this disclosure after considering this specification together with the accompanying drawings. Accordingly, all such changes, modifications, variations and other uses and applications which do not depart from the spirit and scope of the disclosure are deemed to be covered by this disclosure as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present disclosure, as well as equivalents thereof. The details in the patents, patent applications, and publications incorporated by reference herein may be considered to be incorporable at applicant's option, into the claims during prosecution as further limitations in the claims to patently distinguish any amended claims from any applied prior art.

What is claimed is:

1. An appointment scheduling method, comprising:
a first communication device,
a second communication device,
a network, wherein the first communication device and said second communication device communicates with a computing platform through said network;
the computing platform comprising at least a data base and a computing appointment platform, wherein said computing platform is configured to perform operations of:
registering a first user with the computing platform by means of the first communication device;
wherein registering the first user comprises a first data set of first user's information, and
storing the first data set of first user's information in the data base;
registering at least a second user with the computing platform by means of the second communication device, receiving data identifying said second user from the second communication device, wherein registering the second user comprises a second set data of second user's information; wherein said second user's information comprises available appointment time;
receiving from the second user a set of rules to configure said computing appointment platform;
the computing appointment platform generating a second user's schedule comprising available appointment time that complies with the set of rules;
searching means for matching the first user with the second using information at said database for; and
offering the available appointment times to the first user for booking through said computing platform appointment.

2. An appointment scheduling method as set in claim 1, wherein said set of rule comprises:
requiring that the second user confirm a first pending appointment from first user.

3. An appointment scheduling method as set in claim 3, wherein upon confirmation of the first
pending appointment, the appointment is designated as a second user's confirmation for first user access to said second user's schedule, the information is saved in the database and no confirmation is needed from the second user for next appointments performed by the first user.

4. An appointment scheduling method as set in claim 1, wherein first user's information comprises:
adding at least a family member's information, wherein said first user schedule appointment for said family member.

5. An appointment scheduling method as set in claim 1, wherein the means for matching the first user with the second comprises:
a first user's interface that allows the first user to select symptoms, wherein the computing platform matches the symptoms with said second user.

6. An appointment scheduling method as set in claim 1, wherein the means for matching the first user with the second allows the first user to match a second user based on a group selected from consisting of:
a zip code, address, name, location or second user's information.

7. An appointment scheduling method as set in claim 1, wherein the computing platform comprises:
a transaction control system, wherein the transaction control system stores data of all transactions performed on the computer platform device.

8. An appointment scheduling method as set in claim 1, wherein said transaction control system generates reports based on the information stored in said database.
